(19) United States
(12) Patent Application Publication
(10) Pub. No.: US 2007/0057408 A1
(43) Pub. Date: Mar. 15, 2007

(54) Method and apparatus for casting self-compacting concrete mix

(75) Inventors: Leo Sandqvist, Forssa (FI); Lassi Jarvinen, Valkeakoski (FI); Aimo Seppanen, Saaksmaki (FI)

Correspondence Address: BUCHANAN, INGERSOLL & ROONEY PC, POST OFFICE BOX 1404, ALEXANDRIA, VA, 22313-1404, US

(73) Assignee: Elematic Oy Ab, Toijala (FI)

(21) Appl. No.: 11/517,511

(22) Filed: Sep. 8, 2006

(30) Foreign Application Priority Data
Sep. 12, 2005 (FI) 20050906

(51) Int. Cl. B28B 3/00

(52) U.S. Cl. 264/333; 264/40.1; 264/40.4; 425/375; 425/447; 249/117

(57) ABSTRACT

A method and an apparatus for casting self-compacting concrete mix, wherein the self-compacting concrete mix is cast to a mold so that based on the weight and the form of the product to be cast, the total amount of the required concrete mix is determined, the casting points are determined for the product to be cast, at which the concrete mix is cast to the mold, at each casting point the amount of the concrete mix to be cast is determined and the product is cast by casting the determined amounts of concrete mix into the mold at the determined casting points.

The present invention relates to a method and an apparatus for casting self compacting concrete into a mold in mold casting.

Self-compacting concrete (SCC) is used for example in mold casting, in cases where the big amount of reinforcement steel forms too small gaps between the reinforcement, thus preventing the normal concrete from penetrating everywhere in the mold and thus the filling of the mold. In addition, self-compacting concrete is used for products to be cast, when high strength grades are required from the products. The self-compacting concrete is very flowable and it easily fills the narrow gaps and the comers of the mold. For that reason the cast can be performed by pouring concrete from the casting vessel to small molds at one point and to big molds from a couple of different points. The concrete spreads and levels by itself and no separate compacting equipment is needed.

The casting methods and apparatuses of prior art for self-compacting concrete are the same that are used for normal concrete mixes. Thereby the concrete mix is batched into the mold until the mold is filled to the desired height. During the casting process, it is necessary to wait for leveling of the concrete mix between the batching steps in order to see, if the mold is filled. This waiting makes the casting process slower. In addition, the excess amount of mixed concrete must be delivered to a recycling plant.

For solving the above mentioned problems, there is provided a method and an apparatus, said method including first the calculation of the weight and form of the designed product, based on which the amount of the self-compacting concrete required for the product to be cast is determined. Thus, the excess amount of concrete mix can be minimized or totally eliminated.

In the method in accordance with the present invention, the casting apparatus is programmed according to the form of the mold and the product to be cast to batch desired amounts of concrete mix to the desired points. Often one batch from the casting vessel is not enough for casting, but there are several batches of concrete needed, whereby the amounts of concrete mix needed for each batch, as well as the total amount, have been preprogrammed in the system. Thus, the casting is finished when the determined amount of concrete mix is cast to the desired points of the mold.

More precisely, the method according to the present invention is characterized by what is stated in the characterizing part of claim 1, and the apparatus according to the present invention is characterized by what is stated in the characterizing part of claim 6.

The invention will be described in more detail in the following, with reference to the enclosed drawings, wherein

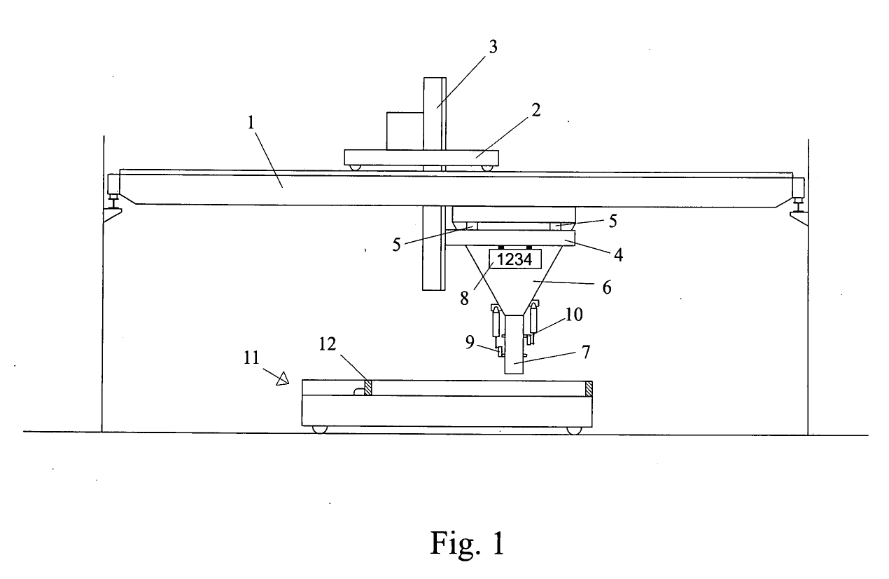

FIG. 1 shows one casting apparatus according to the present invention,

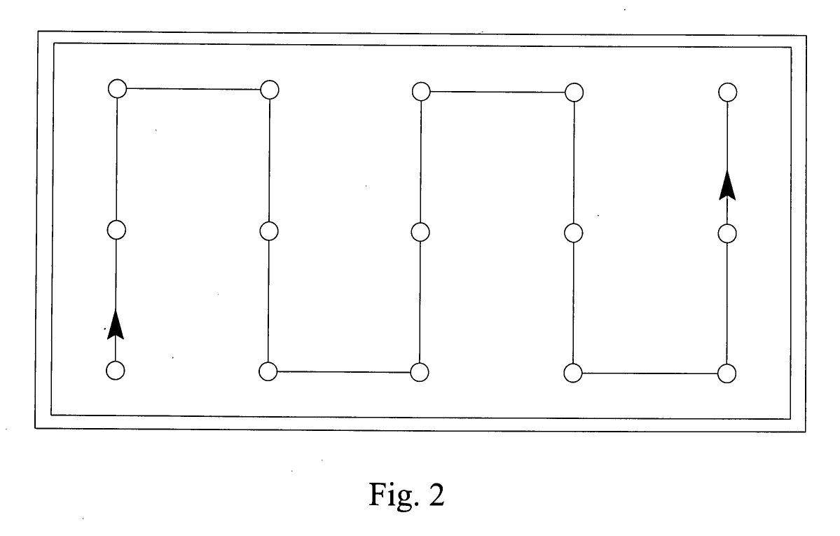

FIG. 2 shows one example of the route of the apparatus according to the invention and the casting points for a closed product to be cast, and

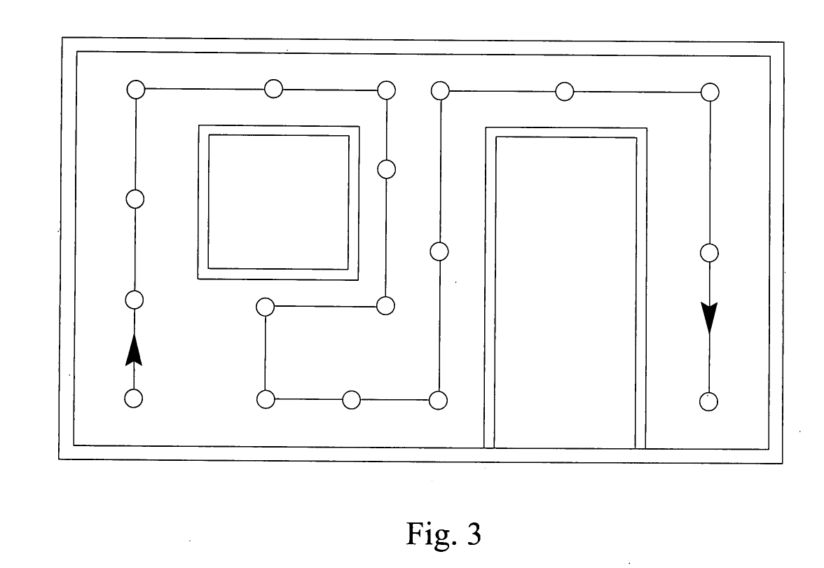

FIG. 3 shows an example of the route of the apparatus according to the invention and the casting points for a product to be cast with openings.

One casting apparatus according to the present invention, shown in FIG. 1, comprises a concrete tank 6, attached to the frame construction 1 by means of a carrier 2, vertical guides 3 attached to the carrier 2 and supports 4 attached to the vertical guides 3. The self-compacting concrete mix is led from the concrete mix tank 6 via pouring pipe 7 to the mold 11 of the product to be cast to an area defined by the side wall construction 12 of the mold 11. The closing valve 9 is used for opening and closing the pouring pipe 7 in order to start and stop the casting. During the filling of the mold with the concrete mix, the flow of the concrete mix is controlled, if necessary, with a flow control valve 10. Sensors 5 for indicating the weight of the self-compacting concrete mix in the tank are mounted between the concrete tank 6 and the supports 4 in order to supply the weight information of the concrete mix to the system controlling the casting apparatus and for example to the indicator 8 of the weight of the remaining concrete mix.

In the solution shown in FIG. 1, the position of the concrete tank 6 on the horizontal level is controlled by changing the location of the carrier 2 and the vertical guides 3. The vertical position of the concrete tank is changed by means of the vertical guides 3 that lift and lower the supports 4. The position control of the concrete tank is preferably arranged e.g. by means of pulse transducers.

FIGS. 2 and 3 show examples of the route of a casting apparatus according to the invention within the area defined by the mold when casting a closed element. FIG. 2 shows the route for a closed product to be cast and FIG. 3 for a product to be cast with openings. In the figures the route is shown by a line with arrows, having circles indicating the casting points, at which the self-compacting concrete mix is fed from the concrete mix tank to the mold in desired amounts.

When determining the route of the casting apparatus, the casting points and the amount of concrete mix to be batched at the casting points, the leveling of the self-compacting concrete mix into an even layer to a desired area are taken into consideration, typically about 0.5-1 m wide around the casting point, as well as the position of the casting point with respect to the sides of the mold and the other casting points. Thus, the correct filling of the mold and the high quality of the product to be cast can be ensured.

The apparatus according to the invention can also be used for casting several products successively as a series. Thereby the casting apparatus can be either moved above a new mold or the molds can be moved successively under the casting apparatus. In addition, the products to be cast can be advantageously also different from each other, because individual amounts of concrete mix and routes and casting points can be determined advantageously for each product to be cast.

When casting successively several products as well as when casting individual products, in the solution according to the present invention, suitable phases for filling the concrete tank with the concrete mix and correct quantities for each filling situation can be determined by controlling the amount of the remaining concrete mix, in order to minimize or totally eliminate the excess amount of the concrete mix.

1. A method for casting a self-compacting concrete mix, whereby the self-compacting concrete mix is cast into a mold wherein
the required total amount of the concrete mix is determined based on the weight and the form of the product to be cast,
casting points are determined for the product to be cast, at which the concrete mix is cast into the mold
the route of the casting apparatus via casting points in the longitudinal and lateral direction is determined,
the amount of the concrete mix to be cast at each casting point is determined, and
the product is cast by casting determined amounts of concrete mix into the mold at the predetermined casting points.

2. A method according to claim 1, wherein the amount of concrete mix determined to be cast at one or at a plurality of casting points is batched into the casting tank prior to the casting and/or during the casting.

3. A method according to claim 1, wherein the casting of the casting mix from the casting tank into the mold is controlled based on the remaining amount of the concrete mix in the casting tank.

4. A method according to claim 1, wherein the casting of the casting mix from the casting tank into the mold is controlled based on the weight of the remaining concrete mix in the casting tank.

5. A method according to claim 1, wherein the casting of the casting mix from the casting tank into the mold is controlled based on the flow rate of the concrete mix.

6. An apparatus for casting self-compacting concrete mix into a mold, said apparatus comprising a casting tank, means for guiding the casting mix from the tank to the mold and means for moving the casting tank, wherein the apparatus further comprises a controlling system for controlling the feed of the casting mix in the longitudinal and lateral direction for casting the determined amounts of concrete mix to the determined points of the casting mold.

7. An apparatus according to claim 6, wherein the apparatus comprises means for determining and tracing the position of the casting point of the apparatus.

8. An apparatus according to claim 6, wherein the apparatus comprises means for determining the amount of concrete mix in the casting tank.

9. An apparatus according to claim 6, wherein the apparatus comprises means for determining the amount of the cast concrete mix.

10. A method according to claim 2, wherein the casting of the casting mix from the casting tank into the mold is controlled based on the remaining amount of the concrete mix in the casting tank.

11. A method according claim 2, wherein the casting of the casting mix from the casting tank into the mold is controlled based on the weight of the remaining concrete mix in the casting tank.

12. A method according claim 3, wherein the casting of the casting mix from the casting tank into the mold is controlled based on the weight of the remaining concrete mix in the casting tank.

13. A method according claim 10, wherein the casting of the casting mix from the casting tank into the mold is controlled based on the weight of the remaining concrete mix in the casting tank.

14. A method according to claim 2, wherein the casting of the casting mix from the casting tank into the mold is controlled based on the flow rate of the concrete mix.

15. A method according to claim 3, wherein the casting of the casting mix from the casting tank into the mold is controlled based on the flow rate of the concrete mix.

16. A method according to claim 4, wherein the casting of the casting mix from the casting tank into the mold is controlled based on the flow rate of the concrete mix.

17. An apparatus according to claim 7, wherein the apparatus comprises means for determining the amount of concrete mix in the casting tank.

18. An apparatus according to claim 7, wherein the apparatus comprises means for determining the amount of the cast concrete mix.

19. An apparatus according to claim 8, wherein the apparatus comprises means for determining the amount of the cast concrete mix.

20. An apparatus according to claim 9, wherein the apparatus comprises means for determining the amount of the cast concrete mix.
